(19) United States
(12) Patent Application Publication
(10) Pub. No.: US 2016/0132819 A1
(43) Pub. Date: May 12, 2016

(54) APPARATUS AND METHODS FOR FILTERING AND DISPLAYING DIFFERENT SCENARIOS

(71) Applicant: COPPERLEAF TECHNOLOGIES INC., Burnaby (CA)

(72) Inventors: Simon Nesbitt HORNER, West Vancouver (CA); Stanley Thomas COLEMAN, North Vancouver (CA); Giuseppe Gnocato, Coquitlam (CA)

(21) Appl. No.: 14/535,125

(22) Filed: Nov. 6, 2014

(51) Int. Cl. G06Q 10/06; G06F 3/0482; G06F 3/0484

(52) U.S. Cl. CPC G06Q 10/063114; G06F 3/04842; G06F 3/0482

(57) ABSTRACT

Apparatus and methods for filtering and displaying different scenarios are provided. Gantt charts illustrating multiple scenarios for performing projects are generated by a computer system. The projects shown in the Gantt charts are filtered by the computer system so that only projects which exhibit differences between the multiple scenarios are displayed. The computer system may display projects with differences that exceed a threshold. Gantt charts may be displayed by computer systems along with risk matrices describing the risks involved in one or more of the projects. Risk matrices plot risk values associated with projects. Computer systems may group projects with similar risk values into bins.

### FIELD OF THE INVENTION

This invention relates to apparatus for assisting users to understand differences between complicated scenarios and to user interfaces for computer systems for displaying such scenarios. The invention also relates to associated methods. The invention has particular application to managing the upgrading and replacement of infrastructure components which include physical equipment used by an enterprise subject to constraints.

### BACKGROUND

Many enterprises involve a large number of pieces of equipment and other infrastructure components which function together to yield some result. For example, an electrical power utility may deliver power through a network made up of generators of various kinds, electrical transformers, electrical switchgear, electrical transmission lines and their components (towers, power poles, wires, insulators, etc.), control systems, substations, monitoring equipment, maintenance equipment, and the like.

As another example, a natural gas utility may deliver natural gas to consumers by way of a system made up of networks of pipelines, compressing stations, valves, monitoring equipment, control equipment, maintenance equipment, gas wells, pressure regulators, and the like. Many other examples also exist. For example, water distribution systems in cities, factories, port operations, railways, and other enterprises all rely on large numbers of pieces of equipment or other physical infrastructure components.

Most, if not all, equipment and other elements of physical infrastructure tend to degrade over time. As a result of such degradation, failures can become more likely. As failures become more likely, the risks of consequences associated with the failures also become higher.

While it is conceivable that an enterprise could function by ignoring proactive maintenance and could simply respond to failures as they occur by fixing or replacing any failed infrastructure component(s), this approach is undesirable in almost all circumstances because it allows the infrastructure to deteriorate to the point that it becomes unreliable. Additionally, this approach does not facilitate informed budgeting for the cost of maintaining the enterprise. Moreover, it may leave the enterprise in a situation where for some period of time there are more failures than the enterprise can accommodate. For example, the enterprise may not have enough manpower or specialized equipment to address more than a certain amount of failures in any one period.

For this reason, many enterprises attempt to proactively maintain and upgrade and replace elements of their infrastructure. In large enterprises, a program of proactive upgrading maintenance and replacement may involve a very large number of projects. Each of these projects will typically be scheduled to occur on a timeline between a start date and an end date.

Scheduling individual projects may be subject to various constraints. For example, maintaining a particular dam may need to be done at particular times of year when the water level behind the dam is low. There may be a link between two or more projects which makes them particularly cost-effective if done together. For example, equipment needed to complete one project at a site may also be used to complete another project at the same site without the need to transport the equipment to the site twice. Some projects may need to be completed in a certain order. For example, if one project involves replacement of a power pole and another project involves replacement of a transformer carried by the power pole, it would make most sense to replace the power pole first and to replace the transformer second. In some cases, larger constraints may limit the number of projects that may be completed at one time. For example, certain projects may require specialized equipment and/or a specialized workforce to complete. Either of these may be in limited supply. As another example, there may be limited financial resources to apply to projects within a certain timeframe.

For any or all of these reasons, establishing a plan as to exactly which projects are going to be completed in which order and when can be very complicated, especially for a large enterprise which may have complicated infrastructure which requires an exceedingly large number of projects to maintain the infrastructure in reliable operating condition.

Scenarios can be a useful planning tool. An organization may establish a scenario for proposed projects in some timeframe (e.g. the next year, the next two years, the next five years, etc.) Such scenarios may be used for scheduling of manpower and equipment; budgeting, and risk assessment to give a few examples.

A computer system may be configured to calculate various things from a scenario. For example, from budgets associated with each scheduled project, a computer system may process a scenario to yield an indication of the amount of spending as a function of time that would occur if the proposed projects went ahead according to the schedule proposed in the scenario. Similarly, information about the projects may be processed to yield an indication of the workforce required as a function of time to complete the projects and/or the amount of equipment or other resources that may be required as a function of time to complete the projects on the schedule proposed in the scenario.

A further complication is that certain projects may need to be completed before certain dates. For example, certain systems may become obsolete. An enterprise may be forced to upgrade or replace such systems before parts or other services become unavailable, especially where the system is being applied in a mission critical application. In addition, failure of certain systems may have potentially very bad consequences such as the potential for harming or killing people or the environment or causing extreme consequential damage to other infrastructure. It may be necessary to upgrade or replace such systems before the condition of the systems deteriorates to the point where the risk or such catastrophic harm is greater than some small threshold. In some industries government regulation also may mandate that certain projects be completed on a particular schedule.

For at least the reasons above, arriving at a scenario that optimally schedules a large number of projects in such a way that keeps the risk of the consequences of failures desirably low while also respecting the various constraints that apply to scheduling the projects can be very difficult.

It is often necessary to tweak or adjust a scenario to reduce risk and/or take advantage of synergies between different projects and/or satisfy a constraint regarding the availability of equipment, manpower, or budget, and/or adapt to changes, etc. This exercise may result in a number of scenarios that are modified relative to one another. Modified scenarios may also result when different scenarios are created with different goals in mind. For example, creating a scenario which would cut the risk of damage to the environment in half for an enterprise might yield a different ordering and timing of projects than a scenario which must be completed within a specified reduced budget. These two scenarios might differ in turn from another scenario which is directed to increasing the production capacity of the enterprise for some particular output period. Ultimately, the decision to adopt a particular scenario as a plan for proceeding is a decision made by a human being. However, it is very hard or impossible for humans to readily grasp exactly how two scenarios which may each include hundreds, thousands, tens of thousands, or ever more projects differ from one another.

With increasingly powerful computing systems, increasingly complicated scenarios may be processed, generating increasingly large amounts of information. Although computing systems enable the generation of this information, systems and methods for displaying such information may not be well-adapted to display such quantities of information in a useful way. The introduction of multiple scenarios multiplies the complexity of already-complex systems, and may render the resulting information impractical for humans to understand. This problem is a consequence of computer systems' introduction to scenario analysis.

Accordingly, there is a need for computer systems which can display scenarios to users in such a way as to allow users to readily grasp the differences between scenarios. There is also a need for computer systems which can direct users' attention to specific projects in a set of scenarios that most affect factors such as the risk of harm, etc.

### SUMMARY

An aspect of the present disclosure provides apparatus for demonstrating differences among a plurality of scenarios for execution of a plurality of projects. The apparatus comprises a display, a data store comprising records corresponding to each of the plurality of scenarios, the records comprising information specifying a start date and an end date for each of the plurality of projects according to the corresponding scenario, and a data processor. The data processor is configured to retrieve from the data store the records corresponding to first and second ones of the scenarios and identify a subset of projects of the plurality of projects that are different between the first and second scenarios by comparing the projects according to one or more subset criteria. The data processor is further configured to display on the display graphical indicia representing the start and end dates for projects of the subset of projects according to the first and second scenarios with the graphical indicia for the start and end dates according to the first and second scenarios interleaved such that the graphical indicia for the start and end dates of a first project according to the first scenario is displayed on the display immediately adjacent to the graphical indicia for the start and end dates of the first project according to the second scenario.

An aspect of the present disclosure provides a method for automatically demonstrating differences among a plurality of scenarios for execution of a plurality of projects with a computer system. The method comprises retrieving, at a processor, records from a data store. The records correspond to first and second scenarios of the plurality of scenarios and comprise information specifying a start date and an end date for each of the plurality of projects according to the corresponding scenario. The method further comprises identifying, at the processor, a subset of projects of the plurality of projects that are different between the first and second scenarios by comparing the start and end dates for the projects in the first scenario and the start and end dates for the projects in the second scenario. The method still further comprises displaying, at a display, graphical indicia representing the start and end dates for projects of the subset of projects according to the first and second scenarios with the graphical indicia for the start and end dates according to the first and second scenarios interleaved such that the graphical indicia for the start and end dates of a first project according to the first scenario is displayed on the display immediately adjacent to the graphical indicia for the start and end dates of the first project according to the second scenario.

An aspect of the present disclosure provides a method for automatically displaying risk information to a user with a computer system. The method comprises retrieving, at a processor, a record from a data store, the record corresponding to a project and comprising information specifying a first risk value having a first risk value type and a second risk value having a second risk value type. The first and second risk values are associated with the project. The method further comprises determining, at the processor, a first range of risk values having the first risk value type and a second range of risk values having the second risk value type and displaying, at a display, a risk matrix comprising the first range of risk values along a first axis and the second range of risk values along a second axis. The first axis is orthogonal to the second axis. The method still further comprises displaying, at the display, a first point on the risk matrix. The first point corresponds to the first and second risk values. The first point is spaced apart from the first axis according to the second risk value and spaced apart from the second axis according to the first risk value.

An aspect of the present disclosure provides an apparatus for automatically displaying risk information to a user. The apparatus comprises a display, a data store and a data processor. The data store comprises a record corresponding to a project. The data store further comprises information specifying a first risk value having a first risk value type and a second risk value having a second risk value type. The first and second risk values are associated with the project. The data processor is configured to retrieve a record from a data store. The record corresponds to a project and comprises information specifying a first risk value having a first risk value type and a second risk value having a second risk value type. The first and second risk values are associated with the project. The data processor is further configured to determine a first range of risk values having the first risk value type and a second range of risk values having the second risk value type and to display, at the display, a risk matrix comprising the first range of risk values along a first axis and the second range of risk values along a second axis. The first axis is orthogonal to the second axis. The data processor is still further configured to display, at the display, a first point on the risk matrix. The first point corresponds to the first and second risk values. The first point is spaced apart from the first axis according to the second risk value and spaced apart from the second axis according to the first risk value.

An aspect of the present disclosure provides methods and apparatus for providing a user interface for interactively demonstrating differences among a plurality of scenarios for execution of a plurality of projects and displaying risk information associated with the plurality of projects to a user. The user interface comprises graphical indicia representing the start and end dates for one or more projects according to first and second scenarios as described herein and one or more points on one or more risk matrices as described herein. The user interface is configured to provide to the user output comprising detailed information relating to a selected element of the user interface in response to a user-selection of the element. Such output may comprise self-modification of the user interface so that one or more displayed elements are modified to highlight one or more elements related to the selected element.

Further aspects and example embodiments are illustrated in the accompanying drawings and/or described in the following description.

### BRIEF DESCRIPTION OF THE DRAWINGS

The accompanying drawings illustrate non-limiting example embodiments of the invention.

FIG. 1 is an illustration showing a prior art display of a Gantt chart for a part of a scenario.

FIG. 2 is a functional diagram of a computer system according to an example embodiment of the invention.

FIG. 3 is a display showing an interleaved Gantt chart with 2 scenarios according to an example embodiment.

FIG. 3A is a display showing of variant of the interleaved Gantt chart of FIG. 3 according to an example embodiment.

FIG. 4 is a view showing an example interleaved Gantt chart with 3 scenarios according to another example embodiment.

FIG. 5A is a view illustrating a 3-by-3 risk matrix according to another example embodiment.

FIG. 5B is a view illustrating a 5-by-5 risk matrix according to another example embodiment.

FIG. 6 is a graph of a curve that models the condition of a particular infrastructure component as a function of time according to an example embodiment.

FIG. 7 is a view of a possible display that includes an interleaved Gantt chart and a plurality of risk matrices.

FIG. 8 is a flowchart illustrating a method according to an example embodiment.

FIG. 9 is a flowchart illustrating a method according to another example embodiment which includes outputting a display of a risk matrix.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

A Gantt chart is one common way to indicate the timing of a large number of projects. A Gantt chart includes a row for each project. Time is indicated by position along the row. Each project is indicated in its corresponding row by a bar which starts at the time at which the project is scheduled to start and which ends at the time at which the project is scheduled to be completed. The Gantt chart includes the same number of rows as there are projects. For a large scenario including many hundreds or thousands (or even more) of projects it would not be possible to display the rows corresponding to all of the projects in the scenario at the same time on one screen and still have bars large enough for a user to make out individual projects and the relationships between them. In practice, a user would need to display only a subset of the projects on the screen at any one time (for example, 50 or fewer rows on a typical display). The user could then scroll up or down through the Gantt chart to view all of the projects in a scenario.

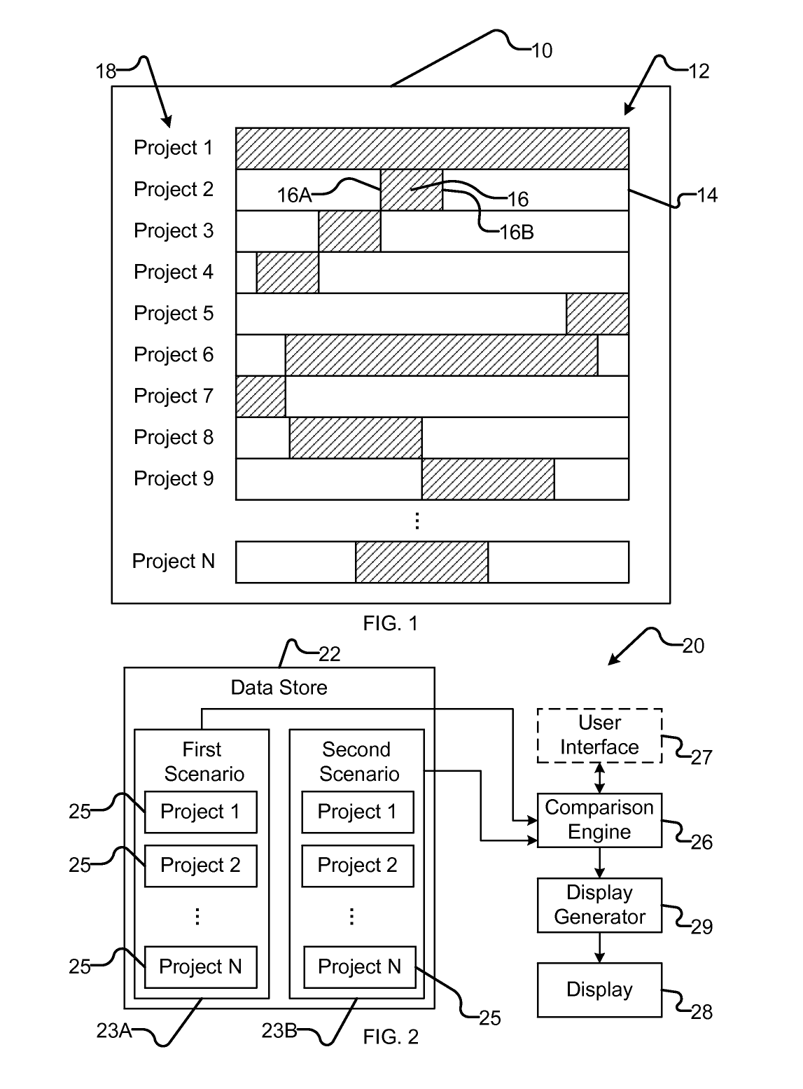

FIG. 1 shows a display 10 displaying a portion of an example prior art Gantt chart 12 which includes rows 14. Each row 14 corresponds to a project. Different projects are identified in FIG. 1 with optional labels 18. A bar 16 is shown in each row. The left edge 16A of each bar 16 indicates the proposed start date for the corresponding project whereas the right edge 16B of each bar 16 represents the proposed completion date for the corresponding project.

The particular scenario to which Gantt chart 12 relates may include many screens full of rows similar to those shown in FIG. 1. Although a display as shown in FIG. 1 permits a user to navigate to any particular project and to see the start and end dates of the project (e.g. by scrolling up and down), this method of display is very user unfriendly for comparing different scenarios, especially if the different scenarios differ from one another only in relation to a small proportion of the total number of projects in the scenarios. This problem is compounded if, for example, a computer system is used to generate scenarios involving a large number of projects and/or scenarios. For example, even 50 projects may be impractical to display in a useful way if 10 scenarios are generated (since there are 500 project-scenario pairs). This problem is much more acute if the number of projects and/or scenarios extends into the hundreds, thousands, tens of thousands, or more.

FIG. 2 is a functional block diagram of a system 20 according to an example embodiment. System 20 includes a data store 22 which includes data structures 23 which specify scenarios (for the sake of convenience, data structures 23 are also referred to as scenarios 23 herein). In the illustrated embodiment, structures 23A and 23B specify first and second scenarios to be processed together. The first and second scenarios 23A, 23B may differ from one another in one or more respects. Each of the first and second scenarios 23A and 23B includes a plurality of projects 25. A significant number of projects 25 overlap between the first and second scenarios. In some embodiments all of the projects 25 from the first scenario 23A are also represented in the second scenario 23B.

In some embodiments, data store 22 comprises a database and the database includes records corresponding to each project 25. The database may, for example, comprise a relational database such as an Oracle™ database. The database may also include records corresponding to each scenario 23. The record for a scenario may, for example, be linked to the records for the various projects that are included in the scenario.

In some cases, a record for a scenario also includes records which correspond to adjustments to projects. For example, the adjustments may alter the start or end dates of a project. As another example, an adjustment may specify a change in the scope of a project, for example by identifying a different one of a plurality of alternative proposals for the project. Differences between the first and second scenarios 23A and 23B may, in some cases, occur as the result of such adjustments in one or both of the scenarios.

Apparatus 20 includes a comparison engine 26 which compares the attributes of corresponding projects 25 that are present in both of the first and second scenarios 23A and 23B and determines whether those attributes are the same or different. In some embodiments, the attributes compared include at least one of the start and end dates for the projects. In some embodiments, the comparison engine 26 searches to identify projects which are associated with different adjustments in one or both scenarios.

Comparison engine 26 may be operated to filter the first and second scenarios in order to identify a subset of the projects 25 included in the first and second scenarios which have attributes that differ. The output of comparison engine 26 is data indicating a subject of projects 25 from the first and second scenarios 23A, 23B. The subset excludes projects 25 that are the same in both scenarios 23A and 23B. Comparison engine 26 may be provided by a computer processor configured to perform the methods hereinafter disclosed. In some embodiments, comparison engine 26 may apply database functions accessed by way of a suitable query language such as Structured Query Language (SQL) to identify projects that differ between two scenarios.

Apparatus 20 may optionally provide a user interface 27 to enable a user to interact with comparison engine 26. For example, user interface 27 may provide control elements which may be operated by a user. In response to such selection, apparatus 20 may configure comparison engine 26 to identify subsets of the projects 25 in a different way. For example, a user may select an on-screen button, press a physical key, say a voice command, or otherwise operate a control element associated with identifying projects based on start dates, in response to which apparatus 20 may configure comparison engine 26 to identify a subset of projects 25 included in the first and second scenarios which have start dates that differ. In response to the user operating a different control element (or, in some embodiments, operating the same control element again and/or in a different way), apparatus 20 may configure comparison engine 26 to identify a subset of projects 25 included in the first and second scenarios which have end dates that differ. User interface 27 may provide control elements allowing users to configure comparison engine 26 to perform any of the methods hereinafter disclosed.

Apparatus 20 includes a display 28 and a display generator 29. Display generator 29 generates images for display on display 28. In some embodiments, display generator 29 generates a Gantt chart display which is limited to only those projects which differ between the first and second scenarios (i.e. the projects in the subject identified by comparison engine 26). In a preferred embodiment, display generator 29 generates an interleaved Gantt chart in which rows corresponding to the first and second scenarios are interleaved with one another. For example, all of the odd numbered rows may correspond to the first scenario whereas all of the even numbered rows may correspond to the second scenario. With this organization, the display may show Gantt chart rows for a project as it would be carried out according to the first scenario and the second scenario in adjacent rows. The display may optionally indicate by way of symbols, colors, pattering or the like projects which differ between the plurality of scenarios being processed in some attribute other than start date and/or end date. Display generator 29 may be provided by an computer processor configured to perform methods as described in this disclosure.

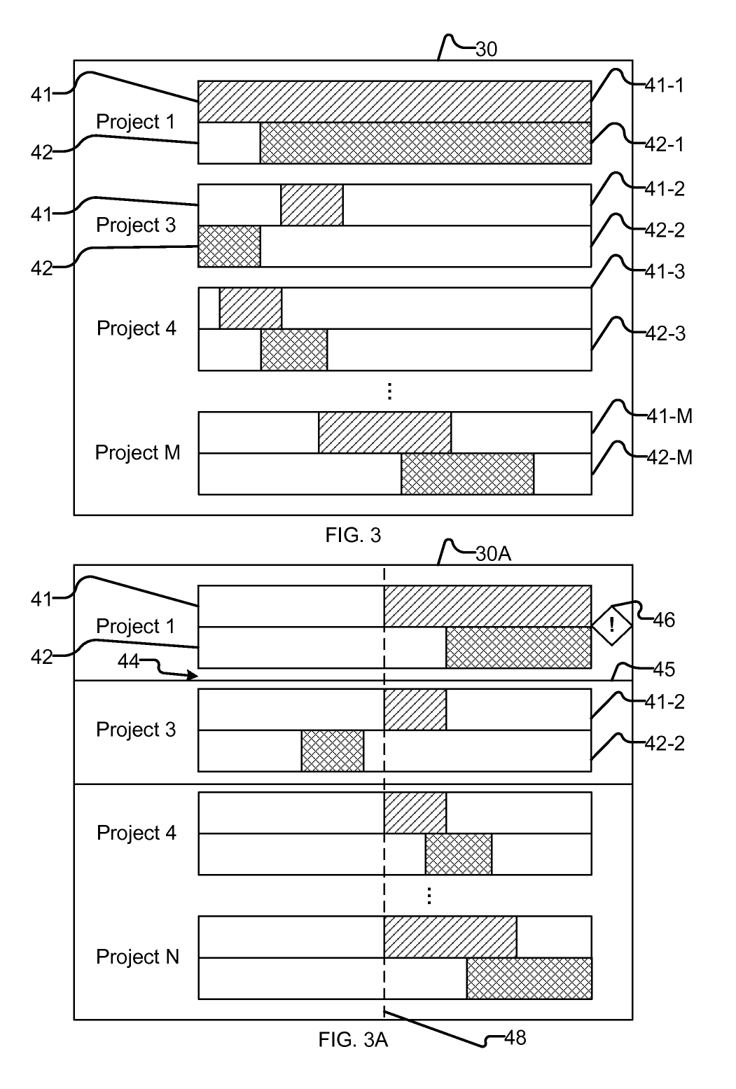

FIG. 3 shows an example of a display 30 that may be displayed on display 28. In FIG. 3, scenario comparison engine 26 has identified those projects 25 for which some attribute is different between the first and second scenarios. Display generator 29 has been configured to display on display 28 only those rows identified as corresponding to projects to which attributes have changed between the scenarios. Suppressing the display of projects that do not satisfy a difference criterion may eliminate the need to display rows for many hundreds or thousands or tens of thousands of projects which are the same or essentially the same in scenarios being compared to one another.

In display 30, odd lines 41-1, 41-2 . . . , 41-M are Gantt chart rows for a number of projects from a first scenario. In between adjacent ones of these rows 41 are rows 42-1, 42-2, . . . 42-M which are Gantt chart rows from a second scenario being compared to the first scenario. With this arrangement, a Gantt chart row 41 from a particular project from the first scenario is displayed immediately adjacent to a Gantt chart row 42 for the same project from the second scenario. Furthermore, only projects for which the project attributes are different as between the first and second scenarios (according to a difference criterion) are displayed. The display of other projects in the first and second scenarios is suppressed. As a result, the number of projects displayed is less than the total number of projects (e.g. projects 25) that are present in both of the first and second scenarios (e.g. scenarios 23A and 23B).

In the display illustrated in FIG. 3, a user can immediately identify which projects are affected by the changes that have been made between the first and second scenarios. The user can also immediately appreciate the differences between the two scenarios, especially to the extent that the differences affect the start and/or end dates for projects. Thus, even if a computer system processes scenarios that include hundreds, thousands, or tens of thousands or more projects, a computer system may further process scenarios relating to those projects to display an amount of information that is not impractical for human understanding.

In some embodiments, display 30 is marked to allow a user to more easily differentiate between different projects. For example, different projects may be displayed using different colors or patterns, as shown in FIG. 3. As another example, as shown in FIG. 3A, variations in spacing 44, dividing lines 45, and/or other indicia may be displayed between adjacent Gantt chart rows which correspond to different projects.

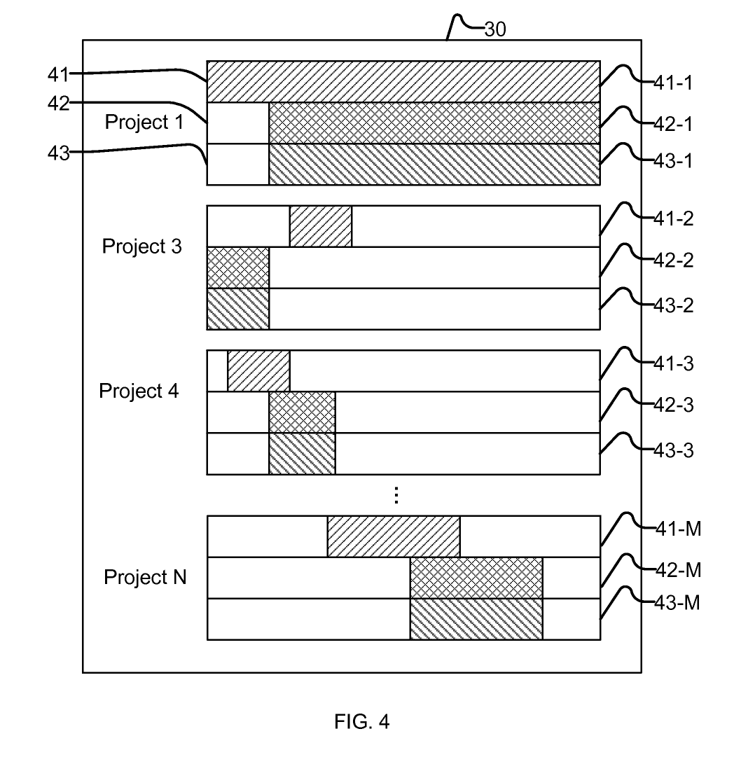

In the embodiment illustrated in FIGS. 3 and 4, each Gantt chart row is aligned with other Gantt chart rows so that the location at which a vertical line intersects all of the displayed Gantt chart rows corresponds to the same time (e.g. a date) in every Gantt chart row. This is not necessary in all embodiments. In some embodiments, a user interface may optionally provide a control which causes start or end dates for all displayed Gantt chart rows for a first scenario to be aligned with one another. For example, as shown in FIG. 3A, a common vertical line 48 may be provided so that all rows corresponding to one scenario (rows 41 in the example embodiment of FIG. 3A) are aligned so that their start times coincide with line 48. Rows corresponding to other scenarios (rows 42 in the example embodiment of FIG. 3A) are arranged so that their start dates are shown relative to the rows aligned with line 48. Thus, in the example depicted in FIG. 3A, it can be easily seen that the start date of project 3 has been moved forward (i.e. is earlier in time) in scenario 2 relative to scenario 1. In some other example embodiments, rows are aligned based on values other than their start dates; for example, they may be aligned based on their end dates.

In some embodiments, a project may have a number of alternatives. For example, a project may be to upgrade a generator. One alternative may be to replace the generator entirely with a brand new generator. Another alternative may be to do a complete overhaul of the generator. A further alternative may be to perform a more limited overhaul of the generator. In some embodiments, a project may include a plurality of alternatives and differences among two scenarios may involve selecting different ones of these alternatives in the two scenarios. In some embodiments an indicia is displayed in or adjacent to the Gantt chart rows for a project when the difference between the scenarios includes a different alternative having been selected for the project. A symbol 46 is shown in FIG. 3A. Symbol 46 indicates that an alternative has changed.

FIG. 4 is an illustration showing another possible display which includes Gantt chart rows from a number of scenarios interleaved with one another. The FIG. 4 example differs from the FIG. 3 example in that three scenarios are being compared. In each case, rows corresponding to the same project in different scenarios are all displayed in a block. This allows a user to immediately see the differences between the scenarios. Rows 43-1, 43-2, . . . 43-M are displayed together with rows 41-1, 41-2, . . . 41-M and rows 42-1, 42-2, . . . 42-M. In the embodiment depicted in FIG. 4, each row 43-i is placed below a corresponding row 42-i. In some embodiments, scenarios which are identical with respect to a particular project may be displayed as a single row; for example, rows 41-i and 42-i may be combined into a single row if the first and second scenarios are identical with respect to a project i.

In some embodiments, a user interface allows a user to alter the filtering and/or sorting of displayed projects. For example, the user interface may include a control that permits the user to toggle between displaying all projects in the two scenarios interleaved with one another and displaying only those projects which differ between the two scenarios in some manner. The user interface may also include controls configured to allow a user to specify one or more threshold differences between the projects in different scenarios for the display of Gantt chart rows corresponding to the projects to be enabled. Different thresholds may be specified for different attributes. For example, different thresholds may be specified for project start and end dates. For example, a user may be able to set a threshold such that the display of Gantt chart rows corresponding to a particular project in two different scenarios is enabled only if there is a difference of at least one week (or some other specified period) in the start and/or end dates of the project between the two scenarios being compared. Different thresholds may apply for cases where the start or end dates are advanced and cases where the start or end dates are delayed. A user interface may provide a user with controls which determine which attributes are compared in determining whether a project differs in two scenarios. If only some attributes are selected for comparison then other attributes of the projects may be ignored in determining whether or not there are differences between the projects.

In addition to sorting the order of displayed projects based on criteria such as a project name, project number, or the like, sorting may additionally or in the alternative be performed based on other criteria. A user interface may provide a control or controls that allow users to alter the criteria used by the system to sort the order in which non-suppressed projects are displayed. In one example embodiment, sorting is performed on the basis of the difference in risk as of a certain date resulting from the differences between the first and second scenarios. This difference may come about, for example, because a particular project in one scenario may improve the condition of an infrastructure component so that risk is reduced. If the second scenario proposes to perform the project in an altered way which results in a smaller improvement to the condition of the infrastructure component then the risk of a failure of the infrastructure component may be higher if the second scenario is performed than it would be if the first scenario is performed, at least at the end of a period in which the first and second scenarios carry out the project in question.

Another sorting mechanism sorts based on the maximum risk in a particular period. For example, suppose that a second scenario proposes to delay a particular project in comparison to the first scenario. The project may be designed to improve the condition of a particular infrastructure component. The delay may permit the component to degrade further in the schedule of the second scenario than would be the case if the project were completed on the schedule proposed in the first scenario. The increased degradation of the component (decrease in the condition of the component) may result in a higher risk occurring for the second scenario in the period between the time that the project was scheduled to be completed in the first scenario and the delayed completion date according to the second scenario. These sorting criteria may optionally additionally take into account the severity of consequences of failure of the infrastructure component in question. This sorting mechanism may permit users to immediately understand a few projects that represent significant differences in the risks to an enterprise that would result from the selection of one scenario over another.

In some embodiments, the selection of which Gantt chart rows to display can optionally be further restricted, for example:
The selection may be limited to display only Gantt chart rows for projects in which the start (or end) date for the project is later according to the second scenario than it is in the first scenario.
The selection may be limited to display only projects for which the start (or end) date is earlier in the second scenario than in the first scenario.
The selection may be limited to display only Gantt chart rows for projects wherein the differences between the first and second scenarios creates a significant difference in risk of failure of an asset as between the first and second scenarios either at any point in a particular period of time (e.g. a current year) or as of a specified date (e.g. an end of a current planning period).
The selection may be limited to display only: projects of certain types (e.g. projects affecting infrastructure components located in a certain geographical area; projects having budgets over a certain amount; projects affecting infrastructure components for which a particular division of an enterprise is responsible; projects affecting infrastructure components which have a certain level of importance (e.g. only projects affecting infrastructure components designated as being mission critical); projects having more than a certain likelihood of causing severe consequences as a result of a failure in a certain time period; and so on.
   A user interface may be provided to allow a user to select the filtering which will be performed to select Gantt chart rows for display and/or to select the order in which the Gantt chart rows will be displayed.

In general, the purpose of projects is to improve the overall condition of an infrastructure used in an enterprise. By improving the condition of the infrastructure, the risk of failures and/or the magnitude of the consequences of the failures may be reduced. A risk matrix is another way to visualize projects which can assist users in understanding the differences between scenarios. Aspects of this disclosure relating to risk matrices may be applied independently of aspects of the disclosure relating to other aspects of the disclosed technology although there is synergy in providing systems which apply both risk matrices and interleaved Gantt charts also as described herein.

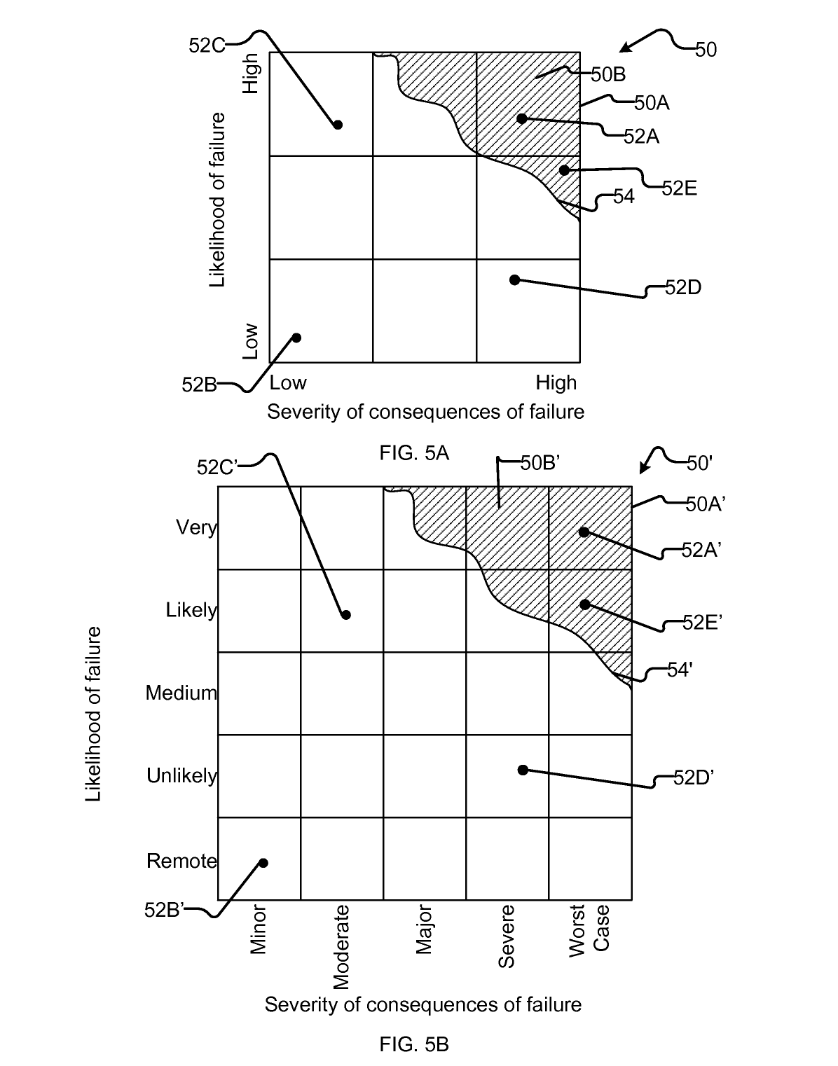

FIGS. 5A and 5B (collectively “FIG. 5”) show examples of risk matrices 50 and 50′. In risk matrices 50 and 50′ one axis (here, the vertical axis) indicates the likelihood of a failure occurring. Another axis (in this example the horizontal axis) indicates the likely severity of consequences that would result if the failure actually occurred. For any given component of an infrastructure (for example, a piece of equipment) a failure of the equipment may contribute to various different risks. For example, an electrical transformer may contain oil that is hazardous if released into the environment. Failure of the transformer in certain modes might result in the release of such oil thus contributing to an environmental risk. Failure of the transformer could also damage other equipment, thus yielding a financial risk. Failure of the transformer could also cut power to certain consumers which is another sort of risk. Failure of the transformer may also introduce the possibility of harm to a human being, which is another type of risk (sometimes referred to herein as “safety risk”). The likelihood that each of these risks could occur may be estimated. The severity of the consequences of a failure may be estimated for each of the different risks being considered. Thus, each element of the infrastructure may be matched to a set of one or more points plotted on risk matrices 50 and 50′. The risk matrix 50 illustrated in FIG. 5A has points 52A through 52E which all correspond to a particular piece of equipment. The risk matrix 50′ illustrated in FIG. 5B has corresponding points 52A′ through 52E′. Each of these points corresponds to a different risk.

FIG. 5A shows an example risk matrix 50 which has been divided into 9 regions corresponding to 3 ranges along the vertical axis (from low likelihood of failure to high likelihood of failure) and 3 ranges along the horizontal axis (from low severity of consequences too high severity of consequences). For the sake of convenience, likelihoods of failure are referred to herein as “likelihoods” and severities of consequences associated with failures are referred to herein as “severities”. FIG. 5B shows an example risk matrix 50′ which has been divided into a greater number of regions to provide more granularity. It is not mandatory that a risk matrix be divided into regions.

Each region along the vertical axis of a risk matrix 50 or 50′ may be provided with a user-friendly label. For example, risk matrix 50′ provides labels ranging from “remote” likelihood to “very” likely. Each label may correspond to an estimate of the likelihood of failure. For example, in one embodiment “remote” corresponds to a 1% likelihood of failure, “unlikely” corresponds to a 3% likelihood of failure, “medium” corresponds to a 10% likelihood of failure, “likely” corresponds to a 33% likelihood of failure, and “very” corresponds to an 80% likelihood of failure. Each label may be provided with these or other corresponding estimates of likelihood.

Each region along the horizontal axis of a risk matrix 50 or 50′ may be provided with a user-friendly label. For example, risk matrix 50′ provides labels ranging from “minor” severity to “worst case” severity. Each label may correspond to an estimate of severity. Estimates of severity may be in nominal units, units of currency, units specific to the type of risk being estimated, and/or other units. For example, if the type of risk being assessed is safety risk (e.g. risk to the safety of staff, contractors, and/or other workers), severity may be measured in terms of an amount of time that the worker could be expected to be away from work, in terms of the amount of care required, and/or in other terms.

For example, “minor” may correspond to a small number of nominal units; e.g., “minor” may correspond to the inverse of the “remote” likelihood (e.g. if remote likelihood corresponds to a 1% chance, a minor severity event may correspond to 100 nominal units of severity), so that the product of remote likelihood and minor severity is 1. “Minor” may, in an example safety context, correspond to 1 week away from work, a minor injury requiring only first aid, and/or the like. “Minor” may, in an example environmental context, correspond to an incident with no lasting damage, whereas “major” may correspond to an incident with lasting environmental harm. As another example, “minor” may correspond to $1000 (e.g. indicating that a minor failure is estimated to incur costs on the order of $1000).

For example, in one embodiment “minor” corresponds to 100 nominal units, “moderate” corresponds to 300 nominal units, “major” corresponds to 1000 nominal units, “severe” corresponds to 3000 nominal units, and “worst case” corresponds to 3000 nominal units. Each label may be provided with these or other corresponding estimates of severity.

In some embodiments, separate risk matrices are provided for different types of risk. For example, financial risk, environmental risk, safety risk, risk to an enterprise's reputation, risk of regulatory infractions, and/or other risks may each be represented in a different risk matrix. In some embodiments, one or more types of risk are represented in one risk matrix. For example, each type of risk may be assigned similar units (e.g. nominal units) for severity and may be presented together along the same axes.

In some embodiments, the vertical and horizontal axes may be reversed, so that the likelihood of failure runs along the horizontal axis and the severity of the consequence of such failure runs along the vertical axis. In some embodiments, estimates of likelihood and/or severity corresponding to one or more labels may be set by a user. In some embodiments, one or more risks may be estimated to have likelihoods and/or severities other than the estimates provided to particular labels.

Clearly, an organization would wish to keep all of its infrastructure in good condition so as to avoid risks occurring in the upper right hand corners 50A and 50A′ of risk matrices 50 and 50′ (corresponding to risks with high likelihood and high severity). Without loss of generality, the following description refers to risk matrix 50 with the understanding the corresponding elements are depicted in FIG. 5B with respect to risk matrix 50′. Corner 50A of risk matrix 50 corresponds to risks with severe consequences being highly likely. An organization may define an exclusive region 50B of risk matrix 50 which includes all or part of the upper right corner 50A of risk matrix 50 in which, as a matter of policy, the enterprise will avoid risks. Exclusive region 50 B may be delineated by a curve (which could be a straight line, a curved line, a set of interconnected line segments, or the like). In the illustrated embodiment, a line 54 is shown. It can be seen that point 52E is in the region 50B above and to the right of line 54.

The likelihood of the risks indicated in a risk matrix 50 depends in general on the condition of the corresponding infrastructure component. Most typically, a new machine is less likely to fail than an old machine. A machine that has recently been refurbished is less likely to fail than a machine that has not. Machines of some types are less likely to fail than machines of other types that have similar functions. Projects can change the condition of infrastructure components. Consequently, completing the projects proposed to be performed in a scenario will change the likelihood of failure of infrastructure components acted on by those projects. For example, a project that involves replacement or refurbishing of an infrastructure component will generally cause points in risk matrix 50 corresponding to the risks being tracked for that infrastructure component on risk matrix 50 to move in the direction of lower risk (e.g. downward). Certain projects may also affect the severity of certain risks. For example, a project may replace toxic oil in a transformer with a more environmentally benign oil, thereby reducing the severity of environmental consequences if the transformer fails in a way that results in release of the oil. A project may replace a generator of a type that can fail catastrophically in a manner that would injure or harm people with a new generator that includes an improved containment structure that makes it unlikely that personnel could be harmed even if the generator fails. Completion of such projects may result in points corresponding to some or all risks on risk matrix 50 to move in a direction of lower severity (e.g. to the left in FIG. 5A).

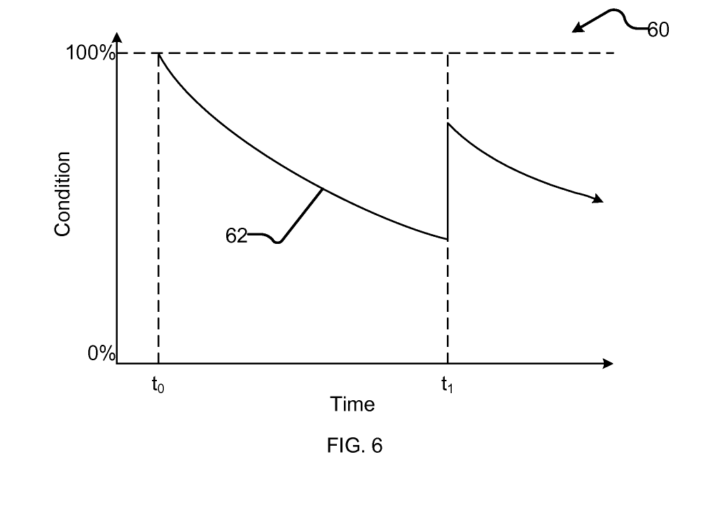

FIG. 6 is a graph 60 of a curve 62 schematically illustrating the condition of a particular generalized example infrastructure component as a function of time. At time t₀, the infrastructure component is new and in top condition. As time progresses, the condition of the infrastructure component deteriorates according to curve 62. The nature of the curve may be different for different types of infrastructure components. The exact curve may vary depending upon things such as the lapse of time, the usage of the infrastructure component, ambient conditions, and the like. Different curves will apply to different infrastructure components. A large enterprise typically has many similar infrastructure components. Curves of condition vs time for similar components will often be similar so that the same prototype curve which shows how condition of an infrastructure component deteriorates over time can be used to construct curves (e.g. curve 62) for many similar infrastructure components or else a curve specified by a few parameters may be used to generate individual curves for a class of infrastructure components. The parameters for a specific infrastructure component may be obtained from tests, measurements of usage (e.g. run hours and/or total output), measurements of ambient conditions or environmental conditions (e.g. maximum temperature, minimum temperature, average or mean temperature, number of freeze-thaw cycles in a desired period, amount of rainfall in a desired period, maximum wind speed, average wind speed, etc.) or the like.

In the curve 52 illustrated in FIG. 6, the infrastructure component is refurbished at time t₁. Refurbishing the infrastructure component in this example does not return the infrastructure component to completely top condition but significantly improves the condition of the infrastructure component. After the infrastructure component has been refurbished the infrastructure component once again continues to degrade according to the prototype curve for infrastructure components of that type. Condition of an infrastructure component (as estimated for example by a curve 62) can be correlated to a probability that the infrastructure component will fail in a given time period.

A risk matrix 50 indicates the likelihood and severity of risks arising from infrastructure components. A risk matrix may represent risk at a particular point in time. For example, each of the risk matrices may indicate the situation at the same time. The time may, for example, be the end of a current planning period, such as a current year. In another embodiment, the points on each risk matrix correspond to the maximum likelihood and severity of the plotted risks in a certain period (e.g. a year, 5-years, or some other period of interest).

In an example embodiment, a system computes and displays a risk matrix for each of a plurality of scenarios. A user viewing the risk matrices may immediately obtain a clear understanding of the effect of the differences between two scenarios on the overall level of risk being accepted by the enterprise. If, in both scenarios, all of the points in the risk matrices are well below line 54 then the user may possibly conclude that each of the scenarios yields an acceptable outcome. On the other hand, if one of the scenarios yields points that are above line 54 then the user may wish to investigate why that is the case. In some embodiments, the total risk corresponding to a point on a risk matrix may be determined by multiplying its likelihood by its severity.

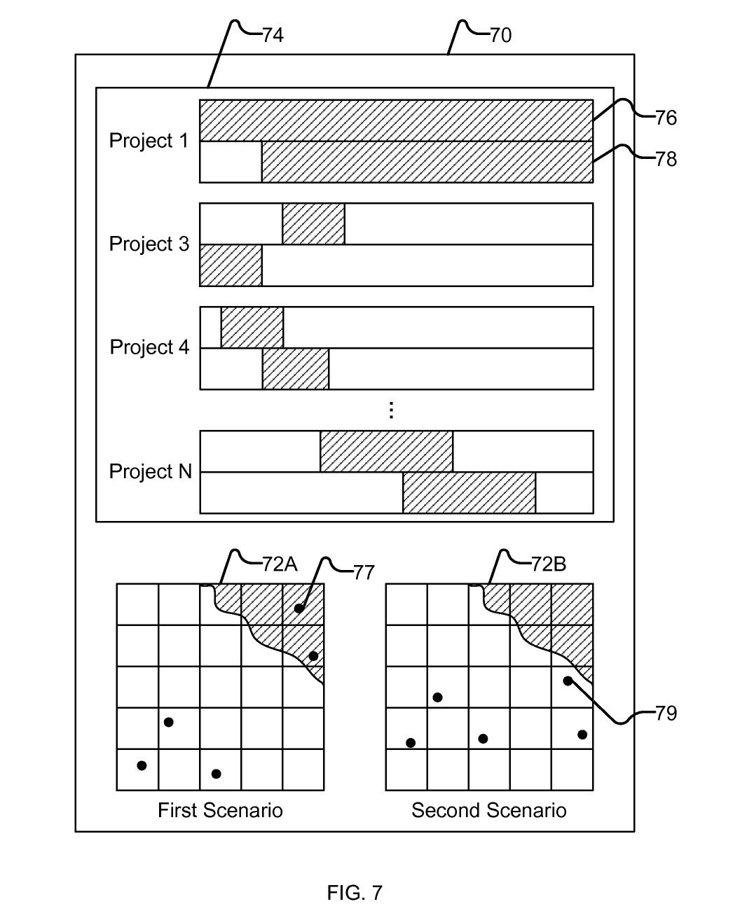

FIG. 7 shows an example display 70 in which the upper half of the display is occupied by an interleaved Gantt chart 74 of the nature illustrated in FIG. 3 whereas the lower part of the display has a plurality of risk matrices 72 displayed in it. In the example embodiment of FIG. 7, risk matrices 72A and 72B correspond respectively to the first and second scenarios for which projects are shown in Gantt chart 74. Display 70 may be generated by, for example, display generator 29.

In some embodiments, risk matrices 72 are part of a graphical user interface such that by selecting points in the risk matrices 72 the Gantt chart 74 will switch to focus on rows of the Gantt chart 74 corresponding to projects which work on the infrastructure components which correspond to the selected points. For example, selecting point 77 may cause Gantt chart 74 to switch to focus on row 76, whereas selecting point 79 may cause Gantt chart 74 to switch to focus on row 78. One project and/or infrastructure component may correspond to a plurality of points in each of risk matrices 72.

In some embodiments, risk matrices 72 are part of a graphical user interface such that by moving a point in the risk matrices 72 to a new location, the corresponding project is adjusted to match the likelihood and/or severity indicated by the new location. Such adjustment may comprise advancing or delaying the timing of the corresponding project (so as to increase or decrease risk values corresponding to the project) and/or selecting a suitable project alternative. Gantt chart 74 may be updated to reflect any adjustments to the project, such as adjusting bars in rows 76, 78 and/or displaying a symbol 46. In some circumstances, it may not be possible to adjust the project to match the risk values corresponding to the new location using the available adjustments, in which case the user may be provided with a warning indicating that no such adjustment is possible. Points may be moved, for example, by dragging points from one location on risk matrix 72 to another location on risk matrix 72 using a computer mouse, trackpad, touch gesture, or the like.

In some embodiments, risk matrices 72 are part of a graphical user interface such that by moving a box in a row 76, 78 of Gantt chart 74 to a new location in its row 76, 78. Moving a box in a row 76, 78 may have a corresponding effect of advancing or delaying the timing of the project, which may correspond to a change in the likelihood and/or severity of the project corresponding to the new location of the box. One or more corresponding points 77, 79 in risk matrices 72 may be adjusted to match the new likelihood and/or severity corresponding to the new location of the box. Boxes may be moved, for example, by dragging boxes from one location in a row 76, 78 to another location in the same row 76, 78 using a computer mouse, trackpad, touch gesture, or the like.

In some embodiments, a plurality of points 77, 79 in risk matrices 72 may correspond to a particular project in Gantt chart 74. Each of the plurality of points 77, 79 may correspond to a likelihood and severity associated with a project alternative for a particular project (e.g. project 1, as shown in FIG. 7). A user may select a point 77, 79 and, in response to such a selection, Gantt chart 74 may be updated to display the corresponding project alternative. For example, a user selection of point 77 may result in row 76 being updated to display different project alternative than was previously displayed.

In some embodiments, risk matrices 72 display points 77, 79 based on likelihood and severity values corresponding to a particular point in time. For example, risk matrices 72 may display likelihood and severity values for the various projects of Gantt chart 74 at the beginning of the displayed time range (e.g., in the depicted example Gantt chart 74, at the time corresponding to the leftmost point on row 76, 78), at the end of the displayed time range, at the mid-point of the displayed time range, and/or at a user-selected point in time (which may or may not be on the displayed time range). The positions of points 77, 79 in risk matrices 72 may vary depending on the particular point in time; for example, in many circumstances the likelihood of risk is reduced after projects are completed, so a later point in time may show lower likelihoods of risk for certain recently-completed projects. In some embodiments, users may select a particular point in time by, for example, moving a user interface element on a timeline (e.g. along rows 76, 78 and/or along a separately-displayed timeline, not depicted), entering a point in time in a text field, identifying a point in time via an API, and/or through other means.

In some embodiments, risk matrices 72 display points 77, 79 based on likelihood and severity values corresponding to a time range. For example, risk matrices 72 may display points 77, 79 based on a time range corresponding to the entire displayed range of time (i.e. all times between and including the leftmost and rightmost points on row 76, 78 in the depicted example Gantt chart 74), over a user-selected time range, and/or over another time range. The likelihood and severity of points 77, 79 may be based on the maximum likelihood and severity values for the various projects of Gantt chart 74 over the time range. The “maximum” likelihood and severity values may be identified by, for example, determining the maximum product of likelihood and severity, e.g. by finding max(risk) across the entire time range, where risk=likelihood×severity for each point in time within the range. As another example, the “maximum” likelihood and severity values may be identified by finding the maximum likelihood and the maximum severity, which may occur at different times within the range, and displaying points 77, 79 on risk matrices 72 corresponding to each of those corresponding points in time. Alternatively, or in addition, likelihood and/or severity values may be selected for display via point 77, 79 based on minimum values, average values, user-selected formulae, and/or other selection criteria.

Display 70 may be part of a user interface which may also comprise, for example, a keyboard, a computer mouse, a trackpad, a touch-sensitive input device, computer monitors, audio speakers, and/or other visual, auditory, and/or tactile input/output devices. A user selection (via an input element of the user interface) of an element of display 70 may cause the user interface to output to the user (e.g. via display 70) additional information relating to the selected element. For example, in response to a user selection of row 76, the user interface may provide to the user detailed information about the project corresponding to row 76 (i.e. project 1) and/or the scenario corresponding to row 76 (i.e. the first scenario). Such detailed information may comprise, for example, the start date of the project according to the scenario, the end date of the project according to the scenario, the projected cost of the project according to the scenario, the maximum likelihood of failure over a time range according to the scenario, the maximum severity of failure over a time range according to the scenario, the maximum likelihood of failure over a time range according to the scenario, the maximum failure risk (likelihood×severity) over a time frame according to the scenario, and/or other information. As another example, in response to a user selection of the label associated with rows 76 and 78 (shown as “Project 1” in FIG. 7), the user interface may provide to the user detailed information about the project corresponding to rows 76 and 78 across all scenarios.

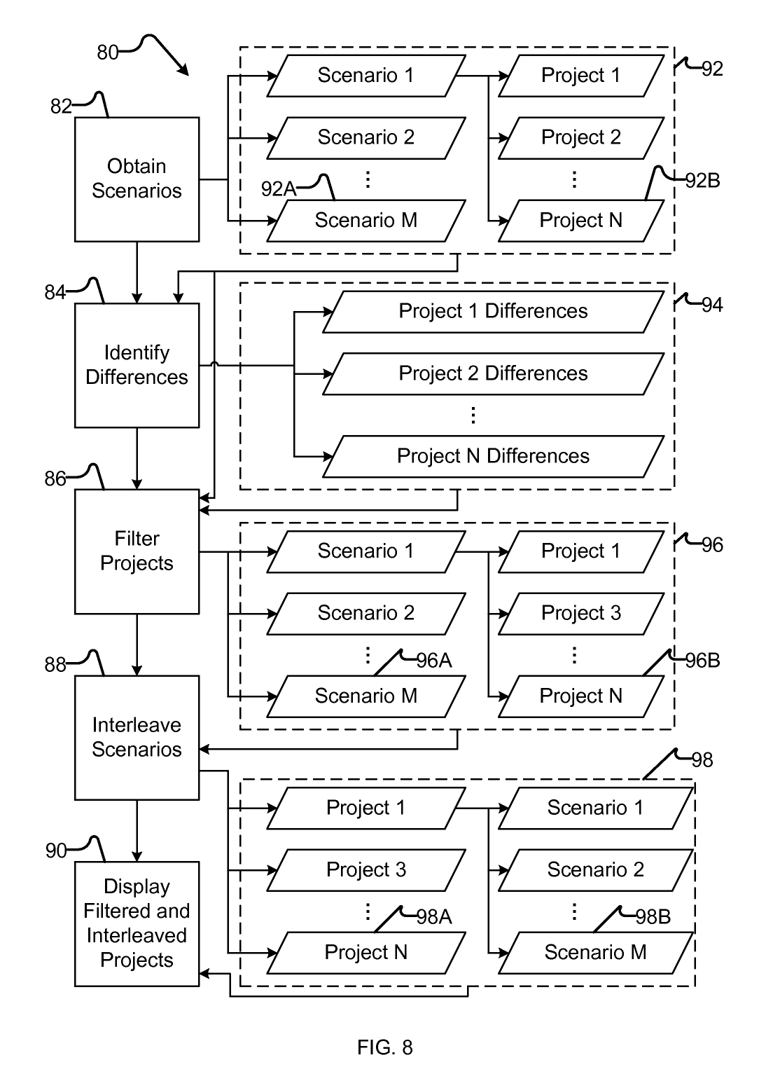

FIG. 8 shows an example filtration and display method 80. Method 80 may be performed by a computer system, including, for example, a computer system comprising a data store 22, comparison engine 26, display generator 29, and display 28. At step 82, the computer system obtains scenario data 92. Scenario data 92 comprises scenarios 92A and projects 92B. Each scenario 92A describes one or more projects 92B. In the example embodiment of FIG. 8, each scenario 92A describes projects 1, 2, . . . N. Scenario data 92 may be received from data store 22. Alternatively, or in addition, scenario data 92 may be dynamically generated, received from a user, or otherwise obtained. For example, projects 92B may be received from data store 22 along with one or more scenarios 92A and the computer system may dynamically generate one or more additional scenarios 92A for the sake of comparison. A user may optionally provide one or more additional scenarios 92A to be compared against the stored and/or dynamically-generated scenarios 92A.

In some embodiments, step 82 also comprises a pre-filtration step. For example, scenario data 92 may be limited to a certain number of scenarios and/or projects. For example, scenario data 92 may only include (and/or may exclude) the first 10,000 projects in data store 22, the first page of scenarios and/or projects in data store 22 (if data store 22 is paged), a user-selected set of scenarios and/or projects, and/or a subset of scenarios and/or projects which meet one or more pre-filtration criteria. For example, scenario data 92 may be limited to projects 92B with risk values exceeding a threshold (e.g. where likelihood and/or severity exceed likelihood and/or severity thresholds, and/or where risk=likelihood×severity exceeds a risk threshold). Risk values may be assessed as of a point in time and/or maybe assessed over a time range; for example, as discussed above, risk values may be assessed based on a maximum risk over a time range. As another example, scenario data 92 may be limited to projects 92B occurring within a particular geographic area (e.g. within 50 kilometers of a city center, within an operational zone defined by a user, and/or otherwise-defined areas).

At step 84, the computer system compares scenarios 92A to identify differences between scenarios 92A. The computer system generates difference data 94 based on this comparison. Step 84 may be performed by, for example, comparison engine 26. Difference data 94 may, for example, identify for each project 92B that is common to at least two scenarios 92A whether or not two or more scenarios 92A describe the project 92B differently. Difference data 94 may, optionally, include a quantification of one or more differences. For example, if project 1 has different start dates in scenarios 1 and 2, and if those start dates differ by one week, then difference data 94 may quantify the difference between scenarios 1 and 2 based on the one-week difference in start dates. Difference data 94 may quantify differences in start dates, end dates, project alternatives (e.g. by identifying whether one scenario selects a different project alternative than another scenario), risk values (including, for example, likelihood and/or severity), and/or other indicia. In some embodiments, different data 94 indicates whether or not a difference exists, without necessarily quantifying one or more differences.

At step 86, the computer system filters projects based on difference data 94 and scenario data 92, generating filtered data 96. Step 86 may be performed by, for example, comparison engine 26 and/or display generator 29. Filtered data 96 comprises scenarios 96A and projects 96B. Scenarios 96A describe projects 96B. Projects 96B may substantially correspond to projects 92B, except that certain projects 92B are excluded from projects 96B. For example, projects 92B for which no difference is identified may be excluded from projects 96B (and thus excluded from filtered data 96). Projects 92B which are not common to at least two scenarios 92A may also be excluded from projects 96B. In some embodiments, all projects 92B are common to all scenarios 92A; a scenario 92A may specify that nothing is done with respect to a particular project 92B. In the example shown in FIG. 8, project 2 has been excluded from projects 96B.

In some embodiments, some projects 92A for which differences have been identified at step 84 may be excluded from filtered data 96. For example, in some embodiments projects 92A are only included in projects 96A if the corresponding difference data 94 includes a quantification which exceeds a threshold. For example, a project 92B may be included in projects 96A only if the start date of the project 92B differs by at least a week between two scenarios 92A. In this example, a project 92B with a start date which differs by at most 6 days between any two scenarios 92A would be excluded from filtered data 96 even if the start date of that project 92B was different between two scenarios.

In some embodiments, a project 92B may be included in or excluded from projects 96B based on multiple factors. For example, a project 92B may be excluded if no two scenarios provide for start dates which differ by week or more, but that exclusion may be overridden (i.e. the project 92B may nevertheless be included in projects 96B) if one or more other factors apply. For example, a project 92B may be included in projects 96B if two scenarios select different project alternatives for the project 92B despite another factor indicating that the project 92B should be excluded. As another example, a project 92B may be included in projects 96B if one or more risk values are different between two scenarios, and/or if one or more costs associated with projects 96B are different between two scenarios. These projects may be included, for example, only if such differences exceed a threshold (which, for example, may be expressed as a percentage, as an absolute difference, and/or in other ways).

In some embodiments, all projects 92B are presumptively included in projects 96B, and may be excluded based on one or more exclusion rules (e.g. by failing to have a difference in start dates greater than a threshold, as discussed above). In some embodiments, all projects 92B are presumptively excluded from projects 96B, and may be included based on one or more inclusion rules (e.g. by providing for different project alternatives in different scenarios). In some embodiments, different inclusion and exclusion rules have orders of precedence. For example, a project with different project alternatives in different scenarios may be included or excluded according to the following list of rules:
1. Projects 92B which are provided with different project alternatives by different scenarios are included in projects 96B;
2. Projects 92B which have the same start and end dates in every scenario are excluded from projects 96B;
3. Projects 92B which have different risk values in different scenarios which differ by more than a threshold between any pair of scenarios are included in projects 96B;
4. Projects 92B which have start and/or end dates which do differ by more than a threshold between each pair of scenarios are included in projects 96B; and
5. Projects 92B which do not meet any of the above rules are excluded from projects 96B.

The computer system may evaluate each project 92B starting with the first rule and cease evaluating the project 92B once a matching rule is found.

At step 88, the computer system interleaves scenarios 96A and projects 96B from filtered data 96 to generate interleaved data 98. Step 86 may be performed by, for example, display generator 29 and/or comparison engine 26. Interleaved data 98 comprises projects 98A and scenarios 98B. Each project 98A is described by scenarios 98A. Projects 98A may substantially correspond to projects 96B and scenarios 98B may substantially correspond to scenarios 96A. In the example embodiment shown in FIG. 8, interleaved data 98 reverses the logical relationship of projects 96B and scenarios 96A so that the project-scenario relationship becomes one-to-many (rather than many-to-one or one-to-one, depending on how filtered data 96 is represented). In some cases, such as where filtered data 96 comprises less than two projects, the relationship between projects 96B and scenarios 96A may be substantially equivalent to the relationship between projects 98A and scenarios 98B.

References to the “logical relationship” between projects and scenarios refers to the manner in which the computer system interacts with the projects and scenarios, and not necessarily a memory representation of those projects and scenarios. For example, the computer system could represent scenarios 92A and projects 92B in memory with a many-to-many relationship. Scenario data 92, filtered data 96, and interleaved data 98 may be represented by different mappings on top of (and/or logical restrictions or subsets of) that many-to-many relationship.

At step 90, the computer system presents a display (e.g. display 30) of information derived from interleaved data 98 to a user. Step 86 may be performed by, for example, display generator 29 and/or a display 28. For example, the display generator may process interleaved data 98 to generate a display 30 of interleaved projects 98A and scenarios 98B substantially as shown in FIGS. 3, 3A, and 4. The interleaved data 98 may optionally be sorted as described above.

In some embodiments, the order in which the steps of method 80 are performed is varied relative to the order depicted in FIG. 8. For example, scenarios may be interleaved at step 88 prior to filtering at step 86 and/or identifying differences at step 84. In some embodiments, steps may be repeated for different portions of data. For example, subset of all scenarios 92A and/or projects 92B may be obtained at step 82. Similarly, differences between a subset of all scenarios 92A and/or projects 92A may be identified at step 84. For instance, differences between two scenarios (e.g. corresponding to rows 41 and 42 in FIG. 4) may be identified at step 84, after which the scenarios and projects considered may be filtered at step 86. Step 84 may be repeated with different subsets of scenarios (e.g. a pair of scenarios corresponding to rows 41 and 43 in FIG. 4) in parallel or at a later time. Projects may be progressively filtered at step 86 over multiple iterations (e.g. by adding to or removing from a list of projects 96B across a plurality of iterations of step 86). Interleaving at step 88 may also, or alternatively, be performed in stages as additional scenarios and/or projects are processed by steps 82, 84, and 86.

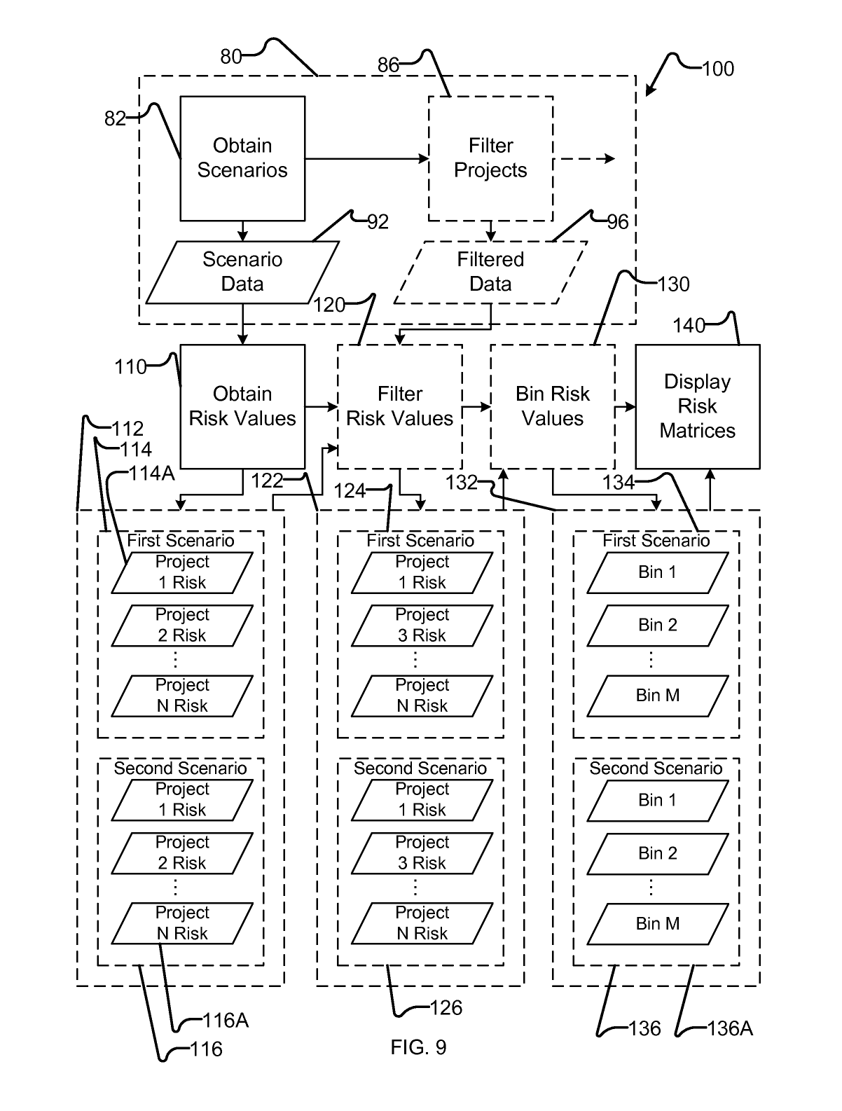

FIG. 9 shows an example risk matrix display method 100. Method 100 may be performed by a computer system, including, for example, a computer system comprising a data store 22, comparison engine 26, display generator 29, and display 28. In the depicted embodiment, method 100 uses scenario data 92 and, optionally, filtered data 96 generated by method 80. In some embodiments, method 100 obtains and/or determines scenario data 92 and/or filtered data 96 (or substantially equivalent data) without necessarily interacting with or depending on method 80. The embodiment of method 100 shown in FIG. 9 may be advantageous in some circumstances, such as when a display 70 as shown in FIG. 7 is desired (as display 70 provides both a Gantt chart 74 and risk matrices 72).

At step 110, the computer system obtains risk values 112 associated with the scenarios represented by scenario data 92. As discussed above, risk values may comprise, for example, likelihoods of component failure and/or measures of the severity of such failure. Risk values may be obtained from a user, calculated based on an estimate of the condition of one or more components (e.g. according to curve 62), or otherwise determined or received. Risk values 112 comprise project risk values 114A, corresponding to the risks associated with each project under a first scenario 114, and project risk values 116A, corresponding to the risks associated with each project under a second scenario 116. Each project may correspond to multiple risks (e.g. a generator may have a worker safety risk corresponding to the possibility that a worker could be harmed by deteriorating equipment as well as a shutdown risk corresponding to the possibility that the generator could simply cease to function). As in method 80, two or more scenarios may be considered by method 100; only two scenarios are shown so as not to further complicate FIG. 9.

At step 120, the computer system may optionally filter risk values 110 so that only a subset of available risk values 112 are shown. For example, the computer system may only include risk values 112 which correspond to projects to be displayed (e.g. projects in filtered data 96 in method 80). For example, a user may indicate (e.g. by a toggle in a user interface) that all risk values 112 are to be shown in risk matrices (e.g. risk matrices 72), or that only those risk values 112 corresponding to the projects to be displayed be shown. As another example, risk values 112 corresponding to a particular projects in scenario data 92 and/or Representing particular types of risk (e.g. safety risk, environmental risk, etc.) the included or excluded. In circumstances where risk values are filtered at block 120, filtered risk values 122 are generated. Filtered risk values 122 comprise filtered scenarios 124 and 126.

At step 130, the computer system may optionally generate binned risk values 132, comprising binned scenarios 134 and 136. Projects which have similar risk values in a given scenario may be grouped together into a bin (e.g. bin 136A). For example, an organization may manage tens of thousands of utility poles. Rather than process and/or display the risk values associated with each utility pole individually (assuming, for the sake of this example, that each utility pole has a corresponding project in scenario data 92), the computer system may group utility poles with similar risk values together so that they can be processed and/or displayed to the user as single value. Binning at step 130 may occur whether or not risk values are filtered at step 120. In some embodiments, binning at step 130 occurs prior to filtering at step 120.

Binning can, in some circumstances, provide advantages to the intelligibility of risk values when displayed to a human user. Binning may optionally be used, for example, when generating a display 70 as shown in FIG. 7.

At step 140, the computer system displays risk matrices based on risk values 112, filtered risk values 122, and/or binned risk values 132, as appropriate. FIG. 9 shows binned risk values 132 being provided to step 140 as input, but it will be understood by the person skilled in the art that other risk values may be used at step 140 depending on which steps had actually been performed. Displaying risk values at step 140 may comprise generating a risk matrix as shown in FIG. 5 and/or FIG. 7. In some embodiments, the display of points on risk matrices (e.g. points 77, 79 on risk matrices 72) may be varied according to the results of step 130. For example, a particular point 77 may correspond to a bin in binned risk values 132; the size of point 77 may increase with the size of the bin (i.e. measured by the number of risk values therein). Alternatively, or in addition, point 77 may be provided with a label indicating the number of risk values in the associated bin (e.g. a label comprising the text “100” may be superimposed on and/or placed proximate to a point 77 associated with a bin containing 100 risk values).

In any of the embodiments described herein the described display may provide a graphical user interface that permits a user who has appropriate credentials to edit one or more of the scenarios being compared and/or to create and edit a new scenario based on a scenario being compared. For example, a user may be able to drag a bar corresponding to a project in a scenario to alter the start and/or end dates for the project. A user may be able to select a project in a scenario to obtain more information about the project in the scenario (e.g. details of alternatives provided by the project, information regarding the budget for the project etc.).

### Example Enumerated Embodiments

The following are some non-limiting enumerated example embodiments:
1. Apparatus for demonstrating differences among a plurality of scenarios for execution of a plurality of projects, the apparatus comprising:
   a. a display;
   b. a data store comprising records corresponding to each of the plurality of scenarios, the records comprising information specifying a start date and an end date for each of the plurality of projects according to the corresponding scenario;
   c. a data processor configured to:
      i. retrieve from the data store the records corresponding to first and second ones of the scenarios;
      ii. identify a subset of projects of the plurality of projects that are different between the first and second scenarios by comparing the projects according to one or more subset criteria;
      iii. display on the display graphical indicia representing the start and end dates for projects of the subset of projects according to the first and second scenarios with the graphical indicia for the start and end dates according to the first and second scenarios interleaved such that the graphical indicia for the start and end dates of a first project according to the first scenario is displayed on the display immediately adjacent to the graphical indicia for the start and end dates of the first project according to the second scenario.
2. Apparatus according to aspect 1 wherein the graphical indicia comprises a bar having a first end in a horizontal position across the display corresponding to the start date for the corresponding project according to the corresponding scenario and a second end in a horizontal position across the display corresponding to the end date for the corresponding project according to the corresponding scenario.
3. Apparatus according to either one of aspect 1 and aspect 2 comprising a graphical user interface for receiving input from a user wherein the processor is configured to, in response to a user interface input either suppress or not suppress display of graphical indicia corresponding to projects not included in the subset.
4. Apparatus according to any one of aspects 1 to 3 wherein one of the subset criteria comprises comparing the start and end dates for the projects in the first scenario and the start and end dates for the projects in the second scenario and including in the subset of projects for which the start and end dates in the first scenario are different than the start and end dates in the second scenario.
5. Apparatus according to aspect 4 wherein the difference between start and end dates in the first scenario and the start and end dates in the second scenario is greater than a date threshold.
6. Apparatus according to any one of aspects 1 to 5 wherein one of the subset criteria comprises including in the subset of projects for which a first project alternative represented by the first scenario is different than a project alternative represented by the second scenario.
7. Apparatus according to any one of aspects 1 to 6 wherein one of the subset criteria comprises comparing a first risk value for the projects in the first scenario and a second risk value for the projects in the second scenario and including in the subset of projects for which the first risk values are different than the second risk values.
8. Apparatus according to aspect 7 wherein the difference between the first and second risk values is greater than a risk threshold.
9. Apparatus according to any one of aspects 1 to 8 wherein the data processor is configured to display on the display graphical indicia representing the start dates for projects of the subset of projects according to the first scenario so that the start dates for projects of the subset of projects according to the first scenario are aligned along a common line; and wherein the data processor is configured to display on the display graphical indicia representing the start dates for projects of the subset of projects according to the second scenario so that the start dates for projects of the subset of projects according to the second scenario are positioned relative in time to the start dates for projects of the subset of projects according to the first scenario.
10. Apparatus according to any one of aspects 1 to 8 wherein the data processor is configured to display on the display graphical indicia representing the start dates for projects of the subset of projects according to the first and second scenarios so that the first project is displayed in an order before a second project, the order of the first and second projects determined according to one or more ordering rules.
11. Apparatus according to aspect 10 wherein one of the one or more ordering rules comprises ordering the first and second projects based on, for each of the first and second projects, a risk difference between a first risk value according to the first scenario and a second risk value according to the second scenario; wherein the risk difference of the first project is greater than the risk difference of the second project.
12. Apparatus according to aspect 11 wherein one of the one or more ordering rules comprises ordering the first and second projects based on, for each of the first and second projects, a maximum risk value of the project according to the one or more of the plurality of scenarios; wherein the maximum risk value of the first project is greater than the maximum risk value of the second project.
13. Apparatus according to any one of aspects 10 to 12 wherein one of the one or more ordering rules comprises ordering the first and second projects based on start dates of the first and second projects.
14. Apparatus according to any one of aspects 10 to 13 wherein one of the one or more ordering rules comprises ordering the first and second projects based on identifiers of project managers associated with the first and second projects.
15. Apparatus according to any one of aspects 10 to 14 wherein one of the one or more ordering rules comprises ordering the first and second projects based on costs associated with the first and second projects.
16. Apparatus according to any one of aspects 10 to 15 wherein one of the one or more ordering rules comprises ordering the first and second projects based on geographic areas associated with the first and second projects.
17. Apparatus according to any one of aspects 10 to 16 wherein:
   one of the one or more ordering rules comprises ordering the first and second projects based on, for each of the first and second projects, a difference between a first risk mitigation value associated with the first project and a second risk mitigation value associated with the second project;
   the first risk mitigation value comprises a difference between a first risk value associated with the first project at a first time and a second risk mitigation value associated with the first project at a second time, the second time following the first time; and
   the second risk mitigation value comprises a difference between a third risk value associated with the second project at a third time and a fourth risk mitigation value associated with the second project at a fourth time, the fourth time following the third time.
18. Apparatus according to any one of aspects 1 to 9 wherein one of the subset criteria comprises including in the subset of projects for which the start date according to the first scenario earlier than the start date according to the second scenario.
19. Apparatus according to any one of aspects 1 to 9 wherein one of the subset criteria comprises including in the subset of projects for which the start date according to the first scenario later than the start date according to the second scenario.
20. Apparatus according to any one of aspects 1 to 19 wherein the data processor is configured to:
   determine, for a risk subset of the plurality of projects, a first risk matrix based on one or more risk values associated with the projects of the risk subset according to the first scenario; and
   display on the display graphical indicia representing the first risk matrix.
21. Apparatus according to aspect 20 wherein the data processor is configured to:
   determine, for the risk subset of the plurality of projects, a second risk matrix based on one or more risk values associated with the projects of the risk subset according to the second scenario; and
   display on the display graphical indicia representing the second risk matrix.
22. Apparatus according to any one of aspects 20 and 21 wherein the one or more risk values comprise a likelihood of risk and a severity of risk.
23. Apparatus according to any one of aspects 20 to 22 wherein the data processor is configured to:
   determine one or more risk similarities of the projects of the risk subset by comparing one or more risk values associated with the projects of the risk subset according to one or more binning criteria; and
   determine one or more risk bins based on the one or more risk similarities; associate with each risk bin one or more projects of the risk subset so that each project associated with a risk bin shares at least one of the one or more risk similarities.
24. Apparatus according to aspect 23 wherein one of the binning criteria comprises comparing a first risk value of a first project with a second risk value of a second project, determining a difference between the first risk value and the second risk value, and, if the difference between the first risk value and the second risk value is less than a risk threshold, determining that the first project and the second project share a risk similarity.
25. A method for automatically demonstrating differences among a plurality of scenarios for execution of a plurality of projects with a computer system, the method comprising:
   retrieving, at a processor, records from a data store, the records corresponding to first and second scenarios of the plurality of scenarios and comprising information specifying a start date and an end date for each of the plurality of projects according to the corresponding scenario;
   identifying, at the processor, a subset of projects of the plurality of projects that are different between the first and second scenarios by comparing the start and end dates for the projects in the first scenario and the start and end dates for the projects in the second scenario; and
   displaying, at a display, graphical indicia representing the start and end dates for projects of the subset of projects according to the first and second scenarios with the graphical indicia for the start and end dates according to the first and second scenarios interleaved such that the graphical indicia for the start and end dates of a first project according to the first scenario is displayed on the display immediately adjacent to the graphical indicia for the start and end dates of the first project according to the second scenario.
26. A method according to aspect 25 wherein the graphical indicia comprises a bar having a first end in a horizontal position across the display corresponding to the start date for the corresponding project according to the corresponding scenario and a second end in a horizontal position across the display corresponding to the end date for the corresponding project according to the corresponding scenario.
27. A method according to either one of aspect 25 and aspect 26 comprising receiving input from a user wherein the processor is configured to, in response to a user interface input either suppress or not suppress display of graphical indicia corresponding to projects not included in the subset.
28. A method according to any one of aspects 25 to 27 wherein one of the subset criteria comprises comparing the start and end dates for the projects in the first scenario and the start and end dates for the projects in the second scenario and including in the subset of projects for which the start and end dates in the first scenario are different than the start and end dates in the second scenario.
29. A method according to aspect 28 wherein the difference between start and end dates in the first scenario and the start and end dates in the second scenario is greater than a date threshold.
30. A method according to any one of aspects 25 to 29 wherein one of the subset criteria comprises including in the subset of projects for which a first project alternative represented by the first scenario is different than a project alternative represented by the second scenario.
31. A method according to any one of aspects 25 to 30 wherein one of the subset criteria comprises comparing a first risk value for the projects in the first scenario and a second risk value for the projects in the second scenario and including in the subset of projects for which the first risk values are different than the second risk values.
32. A method according to aspect 31 wherein the difference between the first and second risk values is greater than a risk threshold.
33. A method according to any one of aspects 25 to 32 comprising:
   displaying, at the display, graphical indicia representing the start dates for projects of the subset of projects according to the first scenario so that the start dates for projects of the subset of projects according to the first scenario are aligned along a common line; and
   displaying, at the display, graphical indicia representing the start dates for projects of the subset of projects according to the second scenario so that the start dates for projects of the subset of projects according to the second scenario are positioned relative in time to the start dates for projects of the subset of projects according to the first scenario.
34. A method according to any one of aspects 25 to 33 comprising displaying, at the display, graphical indicia representing the start dates for projects of the subset of projects according to the first and second scenarios so that the first project is displayed in an order before a second project, the order of the first and second projects determined according to one or more ordering rules.
35. A method according to aspect 34 wherein one of the one or more ordering rules comprises ordering the first and second projects based on, for each of the first and second projects, a risk difference between a first risk value according to the first scenario and a second risk value according to the second scenario; wherein the risk difference of the first project is greater than the risk difference of the second project.
36. A method according to aspect 35 wherein one of the one or more ordering rules comprises ordering the first and second projects based on, for each of the first and second projects, a maximum risk value of the project according to the one or more of the plurality of scenarios; wherein the maximum risk value of the first project is greater than the maximum risk value of the second project.
37. A method according to any one of aspects 35 to 33 wherein one of the subset criteria comprises including in the subset of projects for which the start date according to the first scenario earlier than the start date according to the second scenario.
38. A method according to any one of aspects 35 to 33 wherein one of the subset criteria comprises including in the subset of projects for which the start date according to the first scenario later than the start date according to the second scenario.
39. A method according to any one of aspects 35 to 38 comprising:
   determining, for a risk subset of the plurality of projects, a first risk matrix based on one or more risk values associated with the projects of the risk subset according to the first scenario; and
   displaying, at the display, graphical indicia representing the first risk matrix.
40. A method according to aspect 39 comprising:
   determining, for the risk subset of the plurality of projects, a second risk matrix based on one or more risk values associated with the projects of the risk subset according to the second scenario; and
   displaying, at the display, graphical indicia representing the second risk matrix.
41. A method according to any one of aspects 39 and 40 wherein the one or more risk values comprise a likelihood of risk and a severity of risk.
42. A method according to any one of aspects 39 to 41 comprising:
   determining one or more risk similarities of the projects of the risk subset by comparing one or more risk values associated with the projects of the risk subset according to one or more binning criteria; and
   determining one or more risk bins based on the one or more risk similarities;
   associating with each risk bin one or more projects of the risk subset so that each project associated with a risk bin shares at least one of the one or more risk similarities.
43. A method according to aspect 42 wherein one of the binning criteria comprises comparing a first risk value of a first project with a second risk value of a second project, determining a difference between the first risk value and the second risk value, and, if the difference between the first risk value and the second risk value is less than a risk threshold, determining that the first project and the second project share a risk similarity.
44. A method for automatically displaying risk information to a user with a computer system, the method comprising:
   retrieving, at a processor, a record from a data store, the record corresponding to a project and comprising information specifying a first risk value having a first risk value type and a second risk value having a second risk value type, the first and second risk values associated with the project;
   determining, at the processor, a first range of risk values having the first risk value type and a second range of risk values having the second risk value type;
   displaying, at a display, a risk matrix comprising the first range of risk values along a first axis and the second range of risk values along a second axis, the first axis orthogonal to the second axis; and
   displaying, at the display, a first point on the risk matrix, the first point corresponding to the first and second risk values, the first point spaced apart from the first axis according to the second risk value and spaced apart from the second axis according to the first risk value.
45 A method according to aspect 44 comprising:
   determining, at a processor, a third risk value having a first risk value type and a fourth risk value having a second risk value type, the third and fourth risk values associated with the project;
   displaying, at the display, a second point on the risk matrix, the second point corresponding to the third and fourth risk values, the second point spaced apart from the first axis according to the fourth risk value and spaced apart from the second axis according to the third risk value.
46. A method according to any one of aspects 44 and 45 wherein:
   the first and second risk values correspond to a potential failure associated with the project; and
   the first risk value type is an estimate of a likelihood of the potential failure and the second risk value type is an estimate of a severity of the potential failure.
47. A method according to any one of aspects 44 to 46 comprising:
   receiving, at a user interface, a first user selection corresponding to the point; and
   displaying, at the display, information corresponding to the project.
48. A method according to aspect 47 comprising:
   retrieving, at the processor, a second record from the data store, the second record corresponding to one or more scenarios for execution of the project and comprising information relating to the project according to the one or more scenarios;
   in response to receiving the first user selection, displaying, at the display, the information relating to the project according to at least one of the one or more scenarios.
49. A method according to any one of aspects 44 to 48 comprising:
   receiving, at a user interface, a second user selection corresponding to the point, the second user selection comprising an indication of a first user-selected risk value having the first risk value type and a second user-selected risk value having the second risk value type;
   determining, at the processor, whether the project can be adjusted so as to be associated with the first and second user-selected risk values;
   in response to determining that the project can be adjusted so as to be associated with the first and second user-selected risk values, adjusting the project so as to associate the project with the first and second user-selected risk values; and
   in response to determining that the project cannot be adjusted so as to be associated with the first and second user-selected risk values, displaying a warning to the user.
50. Apparatus for automatically displaying risk information to a user, the apparatus comprising:
   a. a display;
   b. a data store comprising a record corresponding to a project and comprising information specifying a first risk value having a first risk value type and a second risk value having a second risk value type, the first and second risk values associated with the project;
   c. a data processor configured to:
      retrieve a record from a data store, the record corresponding to a project and comprising information specifying a first risk value having a first risk value type and a second risk value having a second risk value type, the first and second risk values associated with the project;
      determine a first range of risk values having the first risk value type and a second range of risk values having the second risk value type;
      display, at the display, a risk matrix comprising the first range of risk values along a first axis and the second range of risk values along a second axis, the first axis orthogonal to the second axis; and
      display, at the display, a first point on the risk matrix, the first point corresponding to the first and second risk values, the first point spaced apart from the first axis according to the second risk value and spaced apart from the second axis according to the first risk value.
51. Apparatus according to aspect 50 wherein the data processor is configured to:
   determine a third risk value having a first risk value type and a fourth risk value having a second risk value type, the third and fourth risk values associated with the project;
   display, at the display, a second point on the risk matrix, the second point corresponding to the third and fourth risk values, the second point spaced apart from the first axis according to the fourth risk value and spaced apart from the second axis according to the third risk value.
52. Apparatus according to any one of aspects 50 and 51 wherein:
   the first and second risk values correspond to a potential failure associated with the project; and
   the first risk value type is an estimate of a likelihood of the potential failure and the second risk value type is an estimate of a severity of the potential failure.
53. Apparatus according to any one of aspects 50 to 52 wherein the data processor is configured to:
   receive, at a user interface, a first user selection corresponding to the point; and
   display, at the display, information corresponding to the project.
54. Apparatus according to aspect 53 wherein the data processor is configured to:
   retrieve a second record from the data store, the second record corresponding to one or more scenarios for execution of the project and comprising information relating to the project according to the one or more scenarios;
   in response to receiving the first user selection, display, at the display, the information relating to the project according to at least one of the one or more scenarios.
55. Apparatus according to any one of aspects 50 to 54 wherein the data processor is configured to:
   receive, at a user interface, a second user selection corresponding to the point, the second user selection comprising an indication of a first user-selected risk value having the first risk value type and a second user-selected risk value having the second risk value type;
   determine whether the project can be adjusted so as to be associated with the first and second user-selected risk values;
   in response to determining that the project can be adjusted so as to be associated with the first and second user-selected risk values, adjust the project so as to associate the project with the first and second user-selected risk values; and
   in response to determining that the project cannot be adjusted so as to be associated with the first and second user-selected risk values, display a warning to the user.
56. Apparatus having any new and inventive feature, combination of features, or sub-combination of features as described herein.
57. Methods having any new and inventive steps, acts, combination of steps and/or acts or sub-combination of steps and/or acts as described herein.

### INTERPRETATION OF TERMS

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in an enterprise computer system may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

While processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Software and other modules may reside on servers, workstations, personal computers, tablet computers, PDAs, and other devices suitable for the purposes described herein.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable instructions on the program product may optionally be compressed or encrypted.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a software module, processor, assembly, device, circuit, display, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. Apparatus for demonstrating differences among a plurality of scenarios for execution of a plurality of projects, the apparatus comprising:
a. a display;
b. a data store comprising records corresponding to each of the plurality of scenarios, the records comprising information specifying a start date and an end date for each of the plurality of projects according to the corresponding scenario;
c. a data processor configured to:
i. retrieve from the data store the records corresponding to first and second ones of the scenarios;
ii. identify a subset of projects of the plurality of projects that are different between the first and second scenarios by comparing the projects according to one or more subset criteria;
iii. display on the display graphical indicia representing the start and end dates for projects of the subset of projects according to the first and second scenarios with the graphical indicia for the start and end dates according to the first and second scenarios interleaved such that the graphical indicia for the start and end dates of a first project according to the first scenario is displayed on the display immediately adjacent to the graphical indicia for the start and end dates of the first project according to the second scenario.

2. Apparatus according to claim 1 wherein the graphical indicia comprises a bar having a first end in a horizontal position across the display corresponding to the start date for the corresponding project according to the corresponding scenario and a second end in a horizontal position across the display corresponding to the end date for the corresponding project according to the corresponding scenario.

3. Apparatus according to claim 1 comprising a graphical user interface for receiving input from a user wherein the processor is configured to, in response to a user interface input either suppress or not suppress display of graphical indicia corresponding to projects not included in the subset.

4. Apparatus according to claim 1 wherein one of the subset criteria comprises comparing the start and end dates for the projects in the first scenario and the start and end dates for the projects in the second scenario and including in the subset of projects for which the start and end dates in the first scenario are different than the start and end dates in the second scenario.

5. Apparatus according to claim 4 wherein the difference between start and end dates in the first scenario and the start and end dates in the second scenario is greater than a date threshold.

6. Apparatus according to claim 1 wherein one of the subset criteria comprises including in the subset of projects for which a first project alternative represented by the first scenario is different than a project alternative represented by the second scenario.

7. Apparatus according to claim 1 wherein one of the subset criteria comprises comparing a first risk value for the projects in the first scenario and a second risk value for the projects in the second scenario and including in the subset of projects projects for which the first risk values are different than the second risk values.

8. Apparatus according to claim 7 wherein the difference between the first and second risk values is greater than a risk threshold.

9. Apparatus according to claim 1 wherein the data processor is configured to display on the display graphical indicia representing the start dates for projects of the subset of projects according to the first scenario so that the start dates for projects of the subset of projects according to the first scenario are aligned along a common line; and wherein the data processor is configured to display on the display graphical indicia representing the start dates for projects of the subset of projects according to the second scenario so that the start dates for projects of the subset of projects according to the second scenario are positioned relative in time to the start dates for projects of the subset of projects according to the first scenario.

10. Apparatus according to claim 10 wherein the data processor is configured to display on the display graphical indicia representing the start dates for projects of the subset of projects according to the first and second scenarios so that the first project is displayed in an order before a second project, the order of the first and second projects determined according to one or more ordering rules.

11. Apparatus according to claim 10 wherein one of the one or more ordering rules comprises ordering the first and second projects based on, for each of the first and second projects, a risk difference between a first risk value according to the first scenario and a second risk value according to the second scenario; wherein the risk difference of the first project is greater than the risk difference of the second project.

12. Apparatus according to claim 11 wherein one of the one or more ordering rules comprises ordering the first and second projects based on, for each of the first and second projects, a maximum risk value of the project according to the one or more of the plurality of scenarios; wherein the maximum risk value of the first project is greater than the maximum risk value of the second project.

13. Apparatus according to claim 10 wherein one of the one or more ordering rules comprises ordering the first and second projects based on start dates of the first and second projects.

14. Apparatus according to claim 10 wherein one of the one or more ordering rules comprises ordering the first and second projects based on identifiers of project managers associated with the first and second projects.

15. Apparatus according to claim 10 wherein one of the one or more ordering rules comprises ordering the first and second projects based on costs associated with the first and second projects.

16. Apparatus according to claim 10 wherein one of the one or more ordering rules comprises ordering the first and second projects based on geographic areas associated with the first and second projects.

17. Apparatus according to a claim 10 wherein:
one of the one or more ordering rules comprises ordering the first and second projects based on, for each of the first and second projects, a difference between a first risk mitigation value associated with the first project and a second risk mitigation value associated with the second project;
the first risk mitigation value comprises a difference between a first risk value associated with the first project at a first time and a second risk mitigation value associated with the first project at a second time, the second time following the first time; and
the second risk mitigation value comprises a difference between a third risk value associated with the second project at a third time and a fourth risk mitigation value associated with the second project at a fourth time, the fourth time following the third time.

18. Apparatus according to claim 1 wherein one of the subset criteria comprises including in the subset of projects for which the start date according to the first scenario earlier than the start date according to the second scenario.

19. Apparatus according to claim 1 wherein one of the subset criteria comprises including in the subset of projects for which the start date according to the first scenario later than the start date according to the second scenario.

20. Apparatus according to claim 1 wherein the data processor is configured to:
determine, for a risk subset of the plurality of projects, a first risk matrix based on one or more risk values associated with the projects of the risk subset according to the first scenario; and
display on the display graphical indicia representing the first risk matrix.

21. Apparatus according to claim 20 wherein the data processor is configured to:
determine, for the risk subset of the plurality of projects, a second risk matrix based on one or more risk values associated with the projects of the risk subset according to the second scenario; and
display on the display graphical indicia representing the second risk matrix.

22. Apparatus according to claim 20 wherein the one or more risk values comprise a likelihood of risk and a severity of risk.

23. Apparatus according to claim 20 wherein the data processor is configured to:
determine one or more risk similarities of the projects of the risk subset by comparing one or more risk values associated with the projects of the risk subset according to one or more binning criteria; and
determine one or more risk bins based on the one or more risk similarities;
associate with each risk bin one or more projects of the risk subset so that each project associated with a risk bin shares at least one of the one or more risk similarities.

24. Apparatus according to claim 23 wherein one of the binning criteria comprises comparing a first risk value of a first project with a second risk value of a second project, determining a difference between the first risk value and the second risk value, and, if the difference between the first risk value and the second risk value is less than a risk threshold, determining that the first project and the second project share a risk similarity.

25. A method for automatically demonstrating differences among a plurality of scenarios for execution of a plurality of projects with a computer system, the method comprising:
retrieving, at a processor, records from a data store, the records corresponding to first and second scenarios of the plurality of scenarios and comprising information specifying a start date and an end date for each of the plurality of projects according to the corresponding scenario;
identifying, at the processor, a subset of projects of the plurality of projects that are different between the first and second scenarios by comparing the start and end dates for the projects in the first scenario and the start and end dates for the projects in the second scenario; and
displaying, at a display, graphical indicia representing the start and end dates for projects of the subset of projects according to the first and second scenarios with the graphical indicia for the start and end dates according to the first and second scenarios interleaved such that the graphical indicia for the start and end dates of a first project according to the first scenario is displayed on the display immediately adjacent to the graphical indicia for the start and end dates of the first project according to the second scenario.

26. A method according to claim 25 wherein the graphical indicia comprises a bar having a first end in a horizontal position across the display corresponding to the start date for the corresponding project according to the corresponding scenario and a second end in a horizontal position across the display corresponding to the end date for the corresponding project according to the corresponding scenario.

27. A method according to claim 25 comprising receiving input from a user wherein the processor is configured to, in response to a user interface input either suppress or not suppress display of graphical indicia corresponding to projects not included in the subset.

28. A method according to claim 25 wherein one of the subset criteria comprises comparing the start and end dates for the projects in the first scenario and the start and end dates for the projects in the second scenario and including in the subset of projects for which the start and end dates in the first scenario are different than the start and end dates in the second scenario.

29. A method according to claim 28 wherein the difference between start and end dates in the first scenario and the start and end dates in the second scenario is greater than a date threshold.

30. A method according to claim 25 wherein one of the subset criteria comprises including in the subset of projects for which a first project alternative represented by the first scenario is different than a project alternative represented by the second scenario.

31. A method according to claim 25 wherein one of the subset criteria comprises comparing a first risk value for the projects in the first scenario and a second risk value for the projects in the second scenario and including in the subset of projects projects for which the first risk values are different than the second risk values.

32. A method according to claim 31 wherein the difference between the first and second risk values is greater than a risk threshold.

33. A method according to claim 25 comprising:
displaying, at the display, graphical indicia representing the start dates for projects of the subset of projects according to the first scenario so that the start dates for projects of the subset of projects according to the first scenario are aligned along a common line; and
displaying, at the display, graphical indicia representing the start dates for projects of the subset of projects according to the second scenario so that the start dates for projects of the subset of projects according to the second scenario are positioned relative in time to the start dates for projects of the subset of projects according to the first scenario.

34. A method according to claim 25 comprising displaying, at the display, graphical indicia representing the start dates for projects of the subset of projects according to the first and second scenarios so that the first project is displayed in an order before a second project, the order of the first and second projects determined according to one or more ordering rules.

35. A method according to claim 34 wherein one of the one or more ordering rules comprises ordering the first and second projects based on, for each of the first and second projects, a risk difference between a first risk value according to the first scenario and a second risk value according to the second scenario; wherein the risk difference of the first project is greater than the risk difference of the second project.

36. A method according to claim 35 wherein one of the one or more ordering rules comprises ordering the first and second projects based on, for each of the first and second projects, a maximum risk value of the project according to the one or more of the plurality of scenarios; wherein the maximum risk value of the first project is greater than the maximum risk value of the second project.

37. A method according to claim 35 wherein one of the subset criteria comprises including in the subset of projects for which the start date according to the first scenario earlier than the start date according to the second scenario.

38. A method according to claim 35 wherein one of the subset criteria comprises including in the subset of projects for which the start date according to the first scenario later than the start date according to the second scenario.

39. A method according to claim 35 comprising:
determining, for a risk subset of the plurality of projects, a first risk matrix based on one or more risk values associated with the projects of the risk subset according to the first scenario; and
displaying, at the display, graphical indicia representing the first risk matrix.

40. A method according to claim 39 comprising:
determining, for the risk subset of the plurality of projects, a second risk matrix based on one or more risk values associated with the projects of the risk subset according to the second scenario; and
displaying, at the display, graphical indicia representing the second risk matrix.

41. A method according to claim 39 wherein the one or more risk values comprise a likelihood of risk and a severity of risk.

42. A method according to claim 39 comprising:
determining one or more risk similarities of the projects of the risk subset by comparing one or more risk values associated with the projects of the risk subset according to one or more binning criteria; and
determining one or more risk bins based on the one or more risk similarities;
associating with each risk bin one or more projects of the risk subset so that each project associated with a risk bin shares at least one of the one or more risk similarities.

43. A method according to claim 42 wherein one of the binning criteria comprises comparing a first risk value of a first project with a second risk value of a second project, determining a difference between the first risk value and the second risk value, and, if the difference between the first risk value and the second risk value is less than a risk threshold, determining that the first project and the second project share a risk similarity.
